(19) United States
(12) Patent Application Publication
(10) Pub. No.: US 2008/0104515 A1
(43) Pub. Date: May 1, 2008

(54) SYSTEM AND METHOD FOR SLIDE PRESENTATION

(76) Inventors: Dan Dumitru, Atlanta, GA (US); Olav A. Sylthe, Oslo (NO); Eshwar Stalin, Atlanta, GA (US)

Correspondence Address: ECKERT SEAMANS CHERIN & MELLOTT, 600 GRANT STREET, 44TH FLOOR, PITTSBURGH, PA, 15219, US

(21) Appl. No.: 11/554,201

(22) Filed: Oct. 30, 2006

(51) Int. Cl. G06F 17/00

(52) U.S. Cl. 715/730

(57) ABSTRACT

Displaying slide presentations in a user interface (UI) on a display screen is enhanced by providing multiple display modes in a slide presentation viewer. A text mode shows text information distilled from the slides. A preview mode shows thumbnail slide images rendered from the slides and a mixed mode shows text information and thumbnails together. The UI further provides a slide show to display the slide images in full screen and an interface (e.g. menu) for selecting among the modes and invoking the slide show. For wireless devices in particular, a network server may process slide presentation documents to generate the text information and slide images for communicating to the wireless devices having slide presentation viewers. The network server may be an attachment server providing services for email attachments and the slide presentation viewers may be attachment viewers.

### FIELD

The present application relates to displaying slide presentations in a user interface (UI) of a computing device, for example, a handheld wireless communication device.

### BACKGROUND

Electronic slide presentations are a common way to present information to one or more viewers. Common slide presentation software and formats include Microsoft® PowerPoint, Apple® iWork Keynote and OpenOffice.org's Impress. Slide presentation software allows users to create multimedia documents incorporating text, images and audio and/or visual clips for presentation in one or more slides. Often the documents are presented in a slideshow, displaying the slides sequentially. The slides may be displayed to a display screen of a computing device (e.g. personal computer) or remotely via a projector to a remote screen.

People on the go rely on handheld communication devices such as wireless mobile devices (cellular phones, PDAs, etc.) among others to keep in contact with others, exchanging electronic messages via email, SMS, IM, etc. Attached to or otherwise accompanying these messages are documents that the handheld user would like to view on the user's handheld communication device. The user desires a viewing experience that is similar to the experience of viewing the document on a personal computer where typically the personal computer has the appropriate software and resources for displaying the document.

Many handheld communication devices do not include full or even reduced versions of slide presentation software. Due to a variety of factors such as constrained storage and/or processor capabilities or expensive or slower communication bandwidth, it may be preferred to process slide presentation documents on another computing device (e.g. a server on a network) capable of coupling to the handheld communication device).

One solution to presenting slide presentations is to distil the presentation document to determine the text information and to transmit this information to the handheld communication device for displaying. However, this experience falls well-short of the user's desire to simulate a personal computer viewing experience and further may result in a loss of significant information contained in the slide presentation in images, graphs, etc.

A solution that addresses one or more of these issues is therefore desired.

### BRIEF DESCRIPTION OF THE DRAWINGS

In order that the subject matter may be readily understood, embodiments are illustrated by way of examples in the accompanying drawings, in which:

FIGS. 1-4 illustrate views of a user interface for displaying slide presentation information in accordance with an embodiment;

FIG. 5 illustrates a communication network system adapted in accordance with an embodiment showing selected components and an example flow of communications for providing a slide presentation to a handheld communication device; and

FIG. 6 is a detailed diagram of a computing device according to the prior art that may be configured as a component of the network system of FIG. 5.

### DETAILED DESCRIPTION

Displaying slide presentation documents in a user interface (UI) on a display screen is enhanced by providing multiple display modes in a slide presentation viewer. A text mode shows text information distilled from the slides. A preview mode shows thumbnail slide images rendered from the slides and a mixed mode shows text information and thumbnail slide images together. The slide presentation viewer further provides a slide show to display the slide images in full screen and an interface (e.g. menu) for selecting among the modes and invoking the slide show. For handheld wireless communication devices in particular, a network server may process slide presentation documents to generate the text information and slide images for communicating to the wireless devices having appropriate slide presentation viewers. The network server may be an attachment server providing services for email attachments and the slide presentation viewers may be attachment viewers for email.

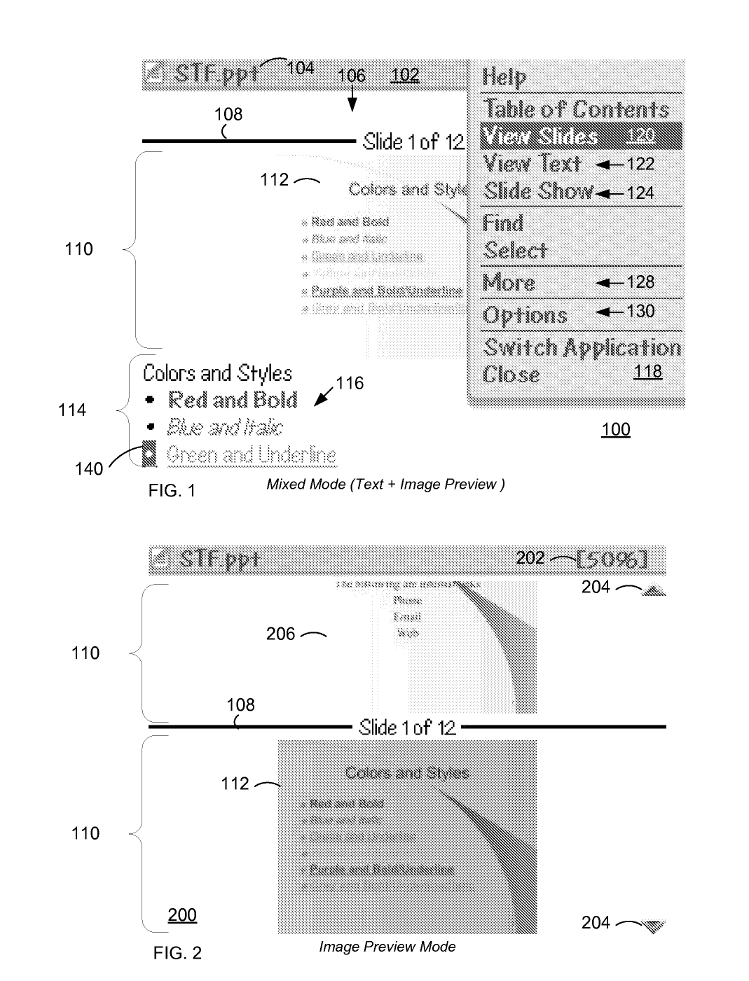

FIGS. 1-4 illustrate representative views (screen shots) of a graphical user interface (GUI) of a slide presentation viewer for displaying slide presentations on a computing device, particularly a handheld wireless communication device. In accordance with the embodiment of the GUI shown and described herein, the GUI provides various modes for displaying the slide presentation to the user. The modes include a mixed mode showing text information and thumbnail slide images, a preview mode showing only the thumbnail slide images and a text mode showing only the text information. As well, the GUI provides a slide show display and a command interface (e.g. a menu) for controlling the viewer.

View 100 of FIG. 1 shows an example view in the mixed mode of a sample slide presentation document (STF.ppt) for displaying, for example, on a display screen of a computing device (not shown). View 100 comprises a top banner portion 102 such as for displaying the name 104 of the slide presentation document and a main body portion 106 below the banner 102 and within which are displayed the slides of the document in the current mode (i.e. mixed mode).

A divider 108 divides the individual slides and may indicate the slide number and total number of slides of the document currently being displayed. Between the dividers 108, each respective slide is displayed in a thumbnail preview format 110 and a text format 114. Thumbnail preview format 110 presents a reduced-size slide image 112 of the slide as it would appear during a slide show and text format 114 shows the text information 116 distilled from the respective slide. The text information 116 is preferably shown in the manner (i.e. font, colour, style and other properties) that it appears in the slide. Font size is typically reduced from the slide size but, preferably, relative sizing is preserved. If the text information 116 appears in a bulleted or other list in the slide, such may be preserved and presented in the text format 114 portion of the mixed mode view 100.

Slides in a mixed mode view 100 may be navigated by a user to scroll about or between slides such as by moving a focus (e.g. cursor 140) about the view 100 using an input device (not shown). Such an input device may comprise a mouse or other pointing device, trackwheel, track ball, and/or key(s). Moving to bring other slides into view 100 may invoke the viewer GUI to request additional slide information (text information and/or slide images) from a network device as describe in further detail below.

View 100 further illustrates a menu 118 that may be invoked by a user to control various functions of the GUI. Pertinent functions include switching display modes such as to View Slides 120 (highlighted by a focus in the menu 118), View Text 122 or to initiate a Slide Show 124. Additional menu choices include More 128 for requesting more slide information for additional slides as will be described below and Options 130 for setting user preferences for the slide presentation viewer GUI. One user option may be setting a default mode for displaying slide presentations. Each time the slide presentation GUI is initially invoked to display a slide presentation document, it may default to a specific display mode such as mixed mode. However, a user may prefer the preview mode showing slide images as a default. Options may also enable a user to set a thumbnail size (e.g. 50% of full size) as a preferred image size.

View 200 of FIG. 2 shows the preview mode displaying the slide presentation document (STF.ppt). This preview mode may be invoked by selecting menu choice View Slides 120 of menu 118. In this mode, dividers 108 divide the slides and main body portion 106 shows only thumbnail preview format 110 (e.g. slides images 206 and 112) and no text format 114. In this or other mode views, file download progress 202 may be indicated. For example 50% indicates that only half of the document available text information has been downloaded from the attachment server. Up/down guides 204 may assist navigation through the slides. A focus may be moved, as per the mixed mode, to bring other slides into view 200. Again, additional slide information may be requested from another computing device as a result of the navigation.

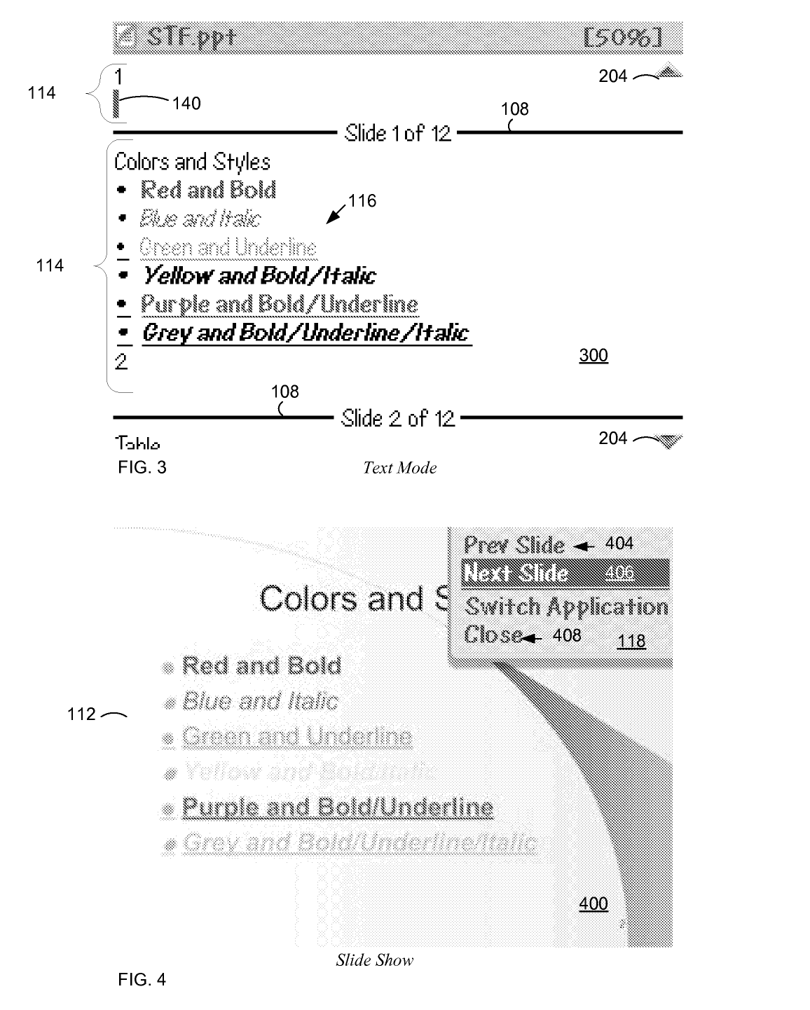

View 300 of FIG. 3 shows the text mode displaying the slide presentation document (STF.ppt). This text mode may be invoked by selecting menu choice View Text 124 of menu 118. In this mode, dividers 108 divide the slides and main body portion 106 shows only text format 114. Up/down guides 204 may assist navigation through the slides. A focus may be moved, as per the mixed mode or preview mode, to bring other slides into view 300. Again, additional slide information (in this case text information) may be requested from another computing device as a result of the navigation.

Text may be searched, selected and copied. Copied text may be pasted into other editable documents (not shown).

View 400 of FIG. 4 shows a slide show view of the slide presentation document (STF.ppt). A slide show may be invoked from menu choice 124. In view 400, slide images (e.g. 112) are shown at their full size typically matching the size of the computing device's display screen. Menu 118 may be context sensitive, and in view 400, when invoked, it shows menu choices for a slide show such as Previous Slide 404 and Next Slide 406. Slide changes in a slide show may also be invoked by input devices (arrow keys, enter, space, etc.). Selecting a Close 408 menu choice stops the slide show view 400 and returns to the current mode of displaying the slide presentation. While in a slide show, the GUI may automatically request slide information from a coupled computing device so that it is ready when needed.

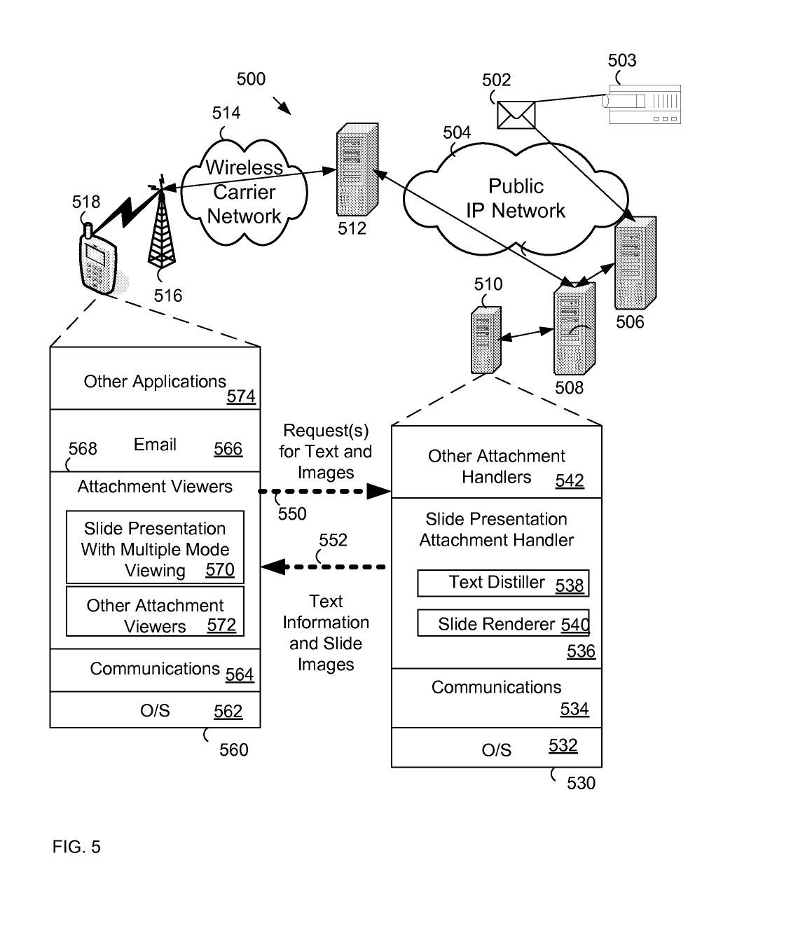

FIGS. 1-4 show a slide presentation viewer GUI with multiple viewing modes and user controls to select among them. A slide show option is further provided. In a preferred embodiment, the viewer is provided on a handheld wireless communication device such as a PDA, smart phone or the like that may be coupled for wireless communication to a network. Slide presentations may be communicated to the handheld communication device, for example, as attachments to electronic communications such as email. FIG. 5 illustrates a communication network system configured in accordance with an embodiment showing selected components of the network and an example flow of communications for providing a slide presentation to a handheld wireless communication device in this scenario.

FIG. 5 shows a communication network system 500 comprising an email 502 including as an attachment a slide presentation document 503 (e.g. STF.ppt) represented as a slide projector. Network system 500 further comprises a public IP network 504, an enterprise email server 506, an enterprise wireless communication device server 508 with an attachment server 510, a wireless network gateway server 512, wireless carrier network 514 and base station 516 and a handheld (wireless) communication device 518. Attachment server 510 and communication device 518 are further illustrated with respective storage components (e.g. computer memory) 530 and 560.

FIG. 5 shows various couplings among the components 502-518. In brief, email 502 is transmitted for delivery to one or more recipients to deliver a slide presentation 503. Delivery may be from a sender computer (not shown) via the public IP network (e.g. the Internet) to a recipient having an email address in a business or other enterprise with enterprise email server 506. Such a server may be a Microsoft Exchange server, IBM Lotus Notes server or another server. The recipient is a user of handheld wireless communication device 518. As such enterprise email server 506 intelligently forwards the email and its attachment to wireless communication device server 508 for delivery to the handheld 518. Wireless communication device server 508 performs various services on behalf of handheld device 518 including security services (encryption), compression, attachment processing via attachment server 510, etc. It may act a gateway back to the email server 506 for email sent by the handheld device 518.

Email 502 processed by server 508 and 510 is transmitted via public IP network 504 to a wireless gateway server 512. From there the email 502 is sent to the device 518 via a wireless carrier network 514 to which the device 518 subscribes or has rights for communications. Persons of ordinary skill in the art will understand the email communication to the device 518 may be in accordance with various different protocols (e.g. push or pull-based) and that details of these delivery mechanisms are not material to the slide presentation viewing methods described herein.

In the present embodiment, servers 508, 510 process the email 502 such that the attachment 503 is not delivered to the device 518 as part of the initial email 502 communication. Rather a link to the attachment 503 is sent and an email application 566 and attachment viewer 570 at the device 518 cooperate to retrieve the attachment via server 508 and 510 as described further.

Handheld wireless communication device 518 is configured (e.g. via software) to comprise various components including an operating system 562, a communications system 564 for wireless communication, and applications 566, 574 such as an email application 566. Email application 566 may comprise or otherwise cooperate with various attachment viewers 568 for retrieving and viewing attachments. One such attachment viewer 568 is slide presentation viewer 570 for viewing in multiple modes as described with reference to FIGS. 1-4. Other viewers 572 may include spreadsheet viewers, image viewers, word processing document viewers, etc. (not described herein).

Attachment server 510 is configured (e.g. via software) to comprise various components including a operating system 532, communications system 534, slide presentation attachment handler 536 as well as other attachment handlers for other attachment types. Slide presentation attachment handler 536 comprises or otherwise cooperates with a text distiller 538 and slide renderer 540. Text distiller 538 is configured to parse or otherwise review slide presentation documents to extract text information for delivery to handheld devices. Slider rendered 540 defines rasterized slide images (e.g. in a jpeg, tiff or other image format) from the slide presentation document for each slide for similar delivery.

The attachment server 510 and/or wireless communication device server 508 and handheld device 518 communicate such that when a user invokes the attachment viewer 570 to view the content of the slide presentation 503, the handheld device 518 transmits one or more requests 550 for slide information, (i.e. the text information (e.g. 116) and slide images (e.g. 112)) and receives same 552 in response. Requests and responses 550 and 552 are illustrated notionally as communicating directly between the handheld device store 560 and attachment server store 530 but it is understood that communications are through network 500 and in particular wireless communication server 508.

Due in part at least to communication protocol constraints on a message's size, a single message may be insufficient to communicate all of the text information and/or all of the slide images for a slide presentation document. Thus, the device 518 may make multiple requests either automatically or in response to direct or indirect user actions. For example, as described above, during a slide show, the slide presentation viewer 570 may automatically make requests for slide information in the background while a user is viewing the slide show (view 400). In the various viewing modes (view 100, view 200 and view 300), as the user navigates the screens, the viewer 570 may anticipate the need for more slide information as a user scrolls toward the end of the slides present on the handheld device. Alternatively, the user may invoke a menu choice (e.g. More 128) for additional slide information, as applicable, to pre-load slides. Should a user attempt to scroll below the slides available on the device, placeholders for the slides being retrieved may be shown or navigation halted and a message displayed that more data is being retrieved (neither is illustrated).

Requests for slide information from the handheld device 518 may indicate whether text information or slide images are to be returned. For example, when the viewer 570 is invoked for a document, an initial request may be for text information only. The response to the device 518 may include a flag or other data that slide images may be delivered, if desired. Accordingly the attachment handler determines that slide images may be rendered to be able to inform the device 518. The viewer 570 may then issue a request for slide images.

Preferably, a request (e.g. for slide information) includes a flag or other data indicating a screen size for the handheld device or use when rendering slide images. This may be a specific pixel size (e.g. 340×280), a code flag (1=340×280 pixels) or a device type, among other types, where the attachment server 510 or wireless communication device server 508 determines the screen size from the code flag or device type. Other display capabilities may be indicated to the attachment server 510 as well or alternatively. For example, the colour capabilities of the display screen (e.g. B/W only or number of colours), reflective type, etc. may be indicated to help render slide images. The attachment server may then adjust the colour palette of the rendered slide presentation for viewing on that device.

Slide presentation viewer 570 provides the GUI described above to present the slides in the various modes and provides a menu or other command interface for user input to invoke the various modes and control the viewer slide presentation. Viewer 570 may further comprise or cooperate with a thumbnail generator (not shown) for the slide images it receives to size them for the preview and mixed modes.

Though not illustrated in FIG. 5, it is understood that handheld device 518 comprises at least a temporary store for storing the text information and slide images it receives. Store 560 may be used. Similarly attachment server 510 and possibly wireless communication device server 508 have respective stores for device requests, slide presentation documents and the text information and slide images rendered. Attachment server 510 and wireless communication device server 508 may be configured such that the attachment server 510 processes the slide presentation document once, rather than in a piecemeal fashion on demand of the handheld device 518 to produce the slide information while the wireless communication server 508 receives and responds to the handheld device's requests for the specific slide information as needed.

To accommodate various slide presentation formats, multiple slide presentation attachment handlers may be used or multiple distillers and renderers may be used for the various formats. Persons of ordinary skill in the art will appreciate that such distillers and renderers will be configured in accordance with the particular formats of the slide presentation documents they can handle.

Though the embodiment shown and described is with respect to email attachments, slide presentations may be communicated to the device 518 as attachments to other electronic communications (e.g. IM) and the attachment viewer 570 be configured to work with a respective device application for such communications. Device 518 may be configured with a retrieval application to retrieve documents from a remote store other than an email store. For example a remote document repository or via LDAP. Slide presentation viewer 570 may be adapted to work with such a retrieval application. Similarly slide presentation attachment handler 536 maybe configured to work with a network server for such a client application.

Though described with reference to an enterprise email server 506 and an enterprise-based wireless communication device server 508 (which are typically coupled in a private network (not shown) behind a firewall(s) (not shown)), other configurations for transmitting electronic communications to a wireless device in a wireless network, particularly a non-enterprise scenario, will be well-known to persons of ordinary skill in the art.

Device 518, or another type of computing device for which a slide presentation viewer as described is implemented, may be capable of communicating in a wired network or other high bandwidth network. Multiple requests/responses for slide information as described may not be necessary in such an network communication system.

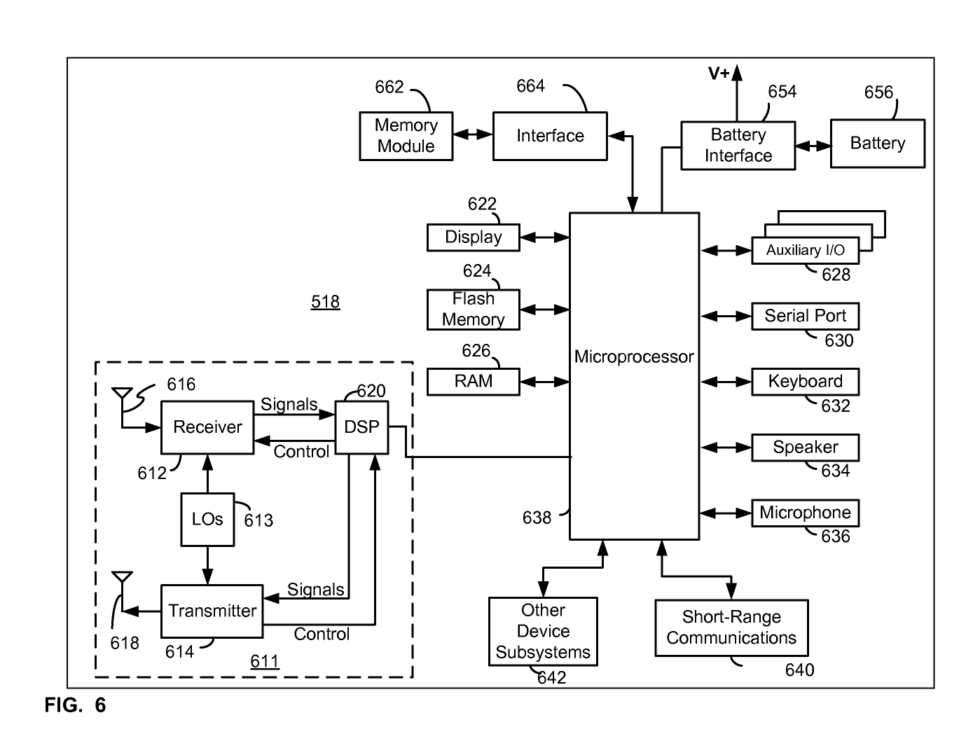

FIG. 6 is a detailed block diagram of an embodiment of a handheld wireless communication device in accordance with the prior art that may be configured as device 518 as described. Handheld device 518 is preferably a two-way communication device having at least voice and advanced data communication capabilities, including the capability to communicate with other computer systems. Depending on the functionality provided by handheld device 518, it may be referred to as a data messaging device, a two-way pager, a cellular telephone with data messaging capabilities, a wireless Internet appliance, or a data communication device (with or without telephony capabilities). Handheld device 518 may communicate with any one of a plurality of base station transceiver systems (not shown) within its geographic coverage area.

Handheld device 518 will normally incorporate a communication subsystem 611, which includes a receiver 612, a transmitter 614, and associated components, such as one or more (preferably embedded or internal) antenna elements 616 and 618, local oscillators (LOs) 613, and a processing module such as a digital signal processor (DSP) 620. As will be apparent to those skilled in field of communications, particular design of communication subsystem 611 depends on the communication network in which handheld device 518 is intended to operate.

Handheld device 518 may send and receive communication signals over the network after required network registration or activation procedures have been completed. Signals received by antenna 616 through the network are input to receiver 612, which may perform such common receiver functions as signal amplification, frequency down conversion, filtering, channel selection, and analog-to-digital (A/D) conversion. A/D conversion of a received signal allows more complex communication functions such as demodulation and decoding to be performed in DSP 620. In a similar manner, signals to be transmitted are processed, including modulation and encoding, for example, by DSP 620. These DSP-processed signals are input to transmitter 614 for digital-to-analog (D/A) conversion, frequency up conversion, filtering, amplification and transmission over communication network via antenna 618. DSP 620 not only processes communication signals, but also provides for receiver and transmitter control. For example, the gains applied to communication signals in receiver 612 and transmitter 614 may be adaptively controlled through automatic gain control algorithms implemented in DSP 620.

Network access is associated with a subscriber or user of handheld device 518, and therefore handheld device 518 comprises a memory module 662, memory module card or a Removable User Identity Module (R-UIM), to be inserted in or connected to an interface 664 in order to operate in the network. Alternatively, memory module 662 may be a non-volatile memory that is programmed with configuration data by a service provider so that mobile station 518 may operate in the network. Since handheld device 518 is a mobile battery-powered device, it also includes a battery interface 654 for receiving one or more rechargeable batteries 656. Such a battery 656 provides electrical power to most if not all electrical circuitry in handheld device 518, and battery interface 654 provides for a mechanical and electrical connection for it. The battery interface 654 is coupled to a regulator (not shown in FIG. 5) that provides power V+ to all of the circuitry.

Handheld device 518 includes a microprocessor 638 that controls overall operation of mobile station 518. Communication functions, including at least data and voice communications, are performed through communication subsystem 611. Microprocessor 638 also interacts with additional device subsystems such as a display 622, a flash memory 624, a random access memory (RAM) 626, auxiliary input/output (I/O) subsystems 628, a serial port 630, a keyboard 632, a speaker 634, a microphone 636, a short-range communications subsystem 640, and any other device subsystems generally designated at 642. Some of the subsystems shown in FIG. 5 perform communication-related functions, whereas other subsystems may provide “resident” or on-device functions. Notably, some subsystems, such as keyboard 632 and display 622, for example, may be used for both communication-related functions, such as entering a text message for transmission over a communication network, and device-resident functions such as a calculator or task list. Operating system software used by microprocessor 638 is preferably stored in a persistent store such as flash memory 624, which may alternatively be a read-only memory (ROM) or similar storage element (not shown). Those skilled in the art will appreciate that the operating system, specific device applications, or parts thereof, may be temporarily loaded into a volatile store such as RAM 626.

Microprocessor 638, in addition to its operating system functions, preferably enables execution of software applications on handheld device 518. A predetermined set of applications that control basic device operations, including at least data and voice communication applications, will normally be installed on handheld device 518 during its manufacture. A preferred application that may be loaded onto handheld device 518 may be a personal information manager (PIM) application having the ability to organize and manage data items relating to a user such as, but not limited to, e-mail, calendar events, voice mails, appointments, and task items. Naturally, one or more memory stores are available on handheld device 518 and memory module 662 to facilitate storage of PIM data items and other information.

The PIM application preferably has the ability to send and receive data items via the wireless network. In a preferred embodiment, PIM data items are seamlessly integrated, synchronized, and updated via the wireless network, with the mobile station user's corresponding data items stored and/or associated with a host computer system thereby creating a mirrored host computer on handheld device 518 with respect to such items. This is especially advantageous where the host computer system is the mobile station user's office or enterprise computer system. Additional applications may also be loaded onto handheld device 518 through network, an auxiliary I/O subsystem 628, serial port 630, short-range communications subsystem 640, or any other suitable subsystem 642, and installed by a user in RAM 626 or preferably a non-volatile store (not shown) for execution by microprocessor 638. Such flexibility in application installation increases the functionality of handheld device 518 and may provide enhanced on-device functions, communication-related functions, or both. For example, secure communication applications may enable electronic commerce functions and other such financial transactions to be performed using handheld device 518.

In a data communication mode, a received signal such as a text message, an e-mail message, or web page download will be processed by communication subsystem 611 and input to microprocessor 638. Microprocessor 638 will preferably further process the signal for output to display 622 or alternatively to auxiliary I/O device 628. A user of handheld device 518 may also compose data items, such as e-mail messages, for example, using keyboard 632 in conjunction with display 622 and possibly auxiliary I/O device 628. Keyboard 632 is preferably a complete alphanumeric keyboard and/or telephone-type keypad. These composed items may be transmitted over a communication network through communication subsystem 611.

For voice communications, the overall operation of handheld device 518 is substantially similar, except that the received signals would be output to speaker 634 and signals for transmission would be generated by microphone 636. Alternative voice or audio I/O subsystems, such as a voice message recording subsystem, may also be implemented. Although voice or audio signal output is preferably accomplished primarily through speaker 634, display 622 may also be used to provide an indication of the identity of a calling party, duration of a voice call, or other voice call related information, as some examples.

Serial port 630 in FIG. 6 is normally implemented in a personal digital assistant (PDA)-type communication device for which synchronization with a user's desktop computer as a desirable, albeit optional, component. Serial port 630 enables a user to set preferences through an external device or software application and extends the capabilities of handheld device 518 by providing for information or software downloads to handheld device 518 other than through a wireless communication network. The alternate download path may, for example, be used to load an encryption key onto handheld device 518 through a direct and thus reliable and trusted connection to thereby provide secure device communication.

Short-range communications subsystem 640 is an additional optional component that provides for communication between handheld device 518 and different systems or devices, which need not necessarily be similar devices. For example, subsystem 640 may include an infrared device and associated circuits and components, or a Bluetooth™ communication module to provide for communication with similarly enabled systems and devices. Bluetooth™ is a registered trademark of Bluetooth SIG, Inc.

Although specific embodiments of the invention have been described herein, it will be understood by those skilled in the art that variations may be made thereto without departing from the spirit of the invention or the scope of the appended claims.

What is claimed is:

1. A method of displaying slides from a slide presentation document in a user interface on a display screen of a computing device, said method comprising:
obtaining text information and slide images generated from the slide presentation document; and
displaying one of the text information and slide images or both on the display screen in user selectable display modes.

2. The method of claim 1 comprising providing an interface to facilitate user selection of the display modes and wherein said display modes comprise:
a text mode for displaying the slides using only the text information;
a preview mode for displaying the slides using only the slide images; and
a mixed mode for displaying the slides using both text information and slide images.

3. The method of claim 2 wherein said interface further facilitates invocation of a slide show to display said the slides as full screen slide images.

4. The method of claim 2 comprising generating thumbnail preview images from said slide images for displaying in said preview mode and said mixed mode.

5. The method of claim 1 wherein said step of obtaining comprises requesting and receiving slide information from a server coupled to the computing device, said server configured to distil said text information and render said slide images from the document, said slide information comprising one or both of said text information and slide images.

6. The method of claim 5 comprising requesting slide information comprising text information before requesting slide information comprising slide images.

7. The method of claim 5 comprising providing an indication of a display screen size of the computing device to said server with which to render said slide images.

8. The method of claim 5 wherein the slide presentation document is an attachment associated with an electronic communication transmitted to the computing device and the server is an attachment server for processing attachments.

9. The method of claim 5 wherein the computing device is a handheld wireless communication device coupled to the server via a communication network comprising a wireless network component and wherein the method comprises:
invoking a slide presentation viewer in response to user input to retrieve and display the attachment.

10. The method of claim 2 comprising displaying a slide divider between the slides.

11. A handheld wireless communication device having a display screen for displaying slides from a slider presentation document, said handheld wireless configured to:
obtain text information and slide images generated from the slide presentation document; and
display one of the text information and slide images or both on the display screen in user selectable display modes.

12. The handheld wireless communication device of claim 11 wherein the handheld device is configured to provide an interface to facilitate user selection of the display modes and wherein said display modes comprise:
a text mode for displaying the slides using only the text information;
a preview mode for displaying the slides using only the slide images; and
a mixed mode for displaying the slides using both text information and slide images.

13. The handheld wireless communication device of claim 12 wherein said interface further facilitates invocation of a slide show to display said the slides as full screen slide images.

14. The handheld wireless communication device of claim 12 wherein the handheld device is configured to generate thumbnail preview images from said slide images for displaying in said preview mode and said mixed mode.

15. The handheld wireless communication device of claim 11 wherein the handheld device is configured to request and receive slide information from a server coupled to the computing device, said server configured to distil said text information and render said slide images from the document, said slide information comprising one or both of said text information and slide images.

16. The handheld wireless communication device of claim 15 wherein the handheld device is configured to request slide information comprising text information before requesting slide information comprising slide images.

17. The handheld wireless communication device of claim 15 wherein the handheld device is configured to provide an indication of its display screen size to said server with which to render said slide images.

18. The handheld wireless communication device of claim 15 wherein the slide presentation document is an attachment associated with an electronic communication transmitted to the handheld device and the server is an attachment server for processing attachments.

19. The handheld wireless communication device of claim 15 wherein the handheld device is coupled to the server via a communication network comprising a wireless network component and wherein the handheld device is configured to invoke a slide presentation viewer in response to user input to retrieve and display the attachment.

20. The handheld wireless communication device of claim 12 wherein the handheld device is configured to display a slide divider between the slides.

21. A computer program product having computer readable code embodied therein, for execution by a processor for configuring a computing device to display slides of a slide presentation document in a user interface on a display screen, said computer program product comprising instructions and data for configuring a processor of the computing device to perform the method of claim 1.

22. A server for processing a slide presentation document to obtain slide information for displaying by a slide presentation viewer of a computing device capable of communication with the server, the server configured to:
distil text information from the document for displaying slides at text;
render slide images from the document for displaying slides as images; and
provide the text information and slide information for communication to the computing device in response to one or more requests for slide information.

23. The server of claim 22 wherein the server comprises an attachment server for processing attachments to electronic messages for delivery to the computing device.

24. The server of claim 22 wherein the server is configured to receive a screen size indicator and render said slide images in response.

25. A method of processing a slide presentation document attached to an electronic message, comprising:
distilling the slide presentation document to define text information from the slides in the document;
rendering slide images depicting the slides in the document;
providing the text information and slide images for display in a slide presentation viewer.

26. The method of claim 25 further comprising receiving a request for the text information before receiving a request for the slide images and distilling and providing the text information in response to the request.

27. The method of claim 26 comprising providing information for a device requesting the text information that slide images can be rendered from the slide presentation document.

28. The method of claim 27 comprising receiving a request for the slide images and providing the slide images in response.

29. A computer program product having computer readable code embodied therein, for execution by a processor of an attachment server, for configuring the server to process a slide presentation document attached to an electronic message, said processing comprising:
distilling the slide presentation document to define text information from the slides in the document;
rendering slide images depicting the slides in the document; and
providing the text information and slide images for display in a slide presentation viewer.

30. The computer program product of claim 29 wherein processing further comprises receiving a request for the text information before receiving a request for the slide images and distilling and providing the text information in response to the request.

31. The computer program product of claim 29 wherein said processing comprises providing information for a device requesting the text information that slide images can be rendered from the slide presentation document.

32. The computer program product of claim 31 wherein said processing comprises receiving a request for the slide images and providing the slide images in response.
